(19) United States
(12) Patent Application Publication
(10) Pub. No.: US 2018/0203655 A1
(43) Pub. Date: Jul. 19, 2018

(54) INFORMATION PROCESSING SYSTEM, INFORMATION PROCESSING METHOD, AND RECORDING MEDIUM

(71) Applicants: Takayori NISHIDA, Kanagawa (JP); Munetake MOROYAMA, Tokyo (JP)

(72) Inventors: Takayori NISHIDA, Kanagawa (JP); Munetake MOROYAMA, Tokyo (JP)

(73) Assignee: Ricoh Company, Ltd., Tokyo (JP)

(21) Appl. No.: 15/743,810

(22) PCT Filed: Jun. 22, 2016
(86) PCT No.: PCT/JP2016/003013

§ 371 Date: Jan. 11, 2018

(30) Foreign Application Priority Data
Jul. 21, 2015 (JP) 2015-143729

(51) Int. Cl. G06F 3/12; H04N 1/00

(52) U.S. Cl. CPC G06F 3/1267; G06F 3/122; G06F 3/1222; H04N 2201/0094; H04N 1/00095; G06F 3/1285; G06F 3/1238

(57) ABSTRACT

An information processing system includes an information processing apparatus and an apparatus connected to each other via a network. The information processing apparatus includes a storage unit to store data to be output by the apparatus, the data being associated with one or more user identifiers of one or more users different from a user of the information processing apparatus, and a first transmission unit to transmit to the apparatus the data associated with a user identifier received from the apparatus. The apparatus includes a second transmission unit to transmit a user identifier of a user of the apparatus to the information processing apparatus, a reception unit to receive from the information processing apparatus the data associated with the user identifier transmitted by the second transmission unit, and an output unit to output the data received by the reception unit.

### TECHNICAL FIELD

The present disclosure relates to an information processing system, an information processing method, and a recording medium.

### BACKGROUND

There is known in the art a technique of outputting print data such as extended confidential printing or pull printing. In this technique, when a print instruction for printing document data is input by a user on a client personal computer (PC), print data created based on the document data is stored in the client PC without being transmitted immediately to an image forming apparatus. If the user operates an image forming apparatus such as a multifunction peripheral (MFP) to input a user ID assigned to the user, the image forming apparatus displays a list of print data items stored in the client PC of the user and associated with the user ID to receive a selection of a printing target from the user. After a print data item is selected from the displayed list by the user, the image forming apparatus performs a print job based on the selected print data item.

In the above-described technique, a list of print data items of print instructions input by a user who operates the image forming apparatus is displayed on the image forming apparatus to receive a selection of a printing target from the user. Hence, it is possible to prevent printed matters requested by other people from being accidentally output. In addition, a printed matter is output from the image forming apparatus when the user is in a vicinity of the image forming apparatus, and it is possible to reduce the possibility that confidential information or the like is revealed to other people.

Further, the extended confidential printing provides a function (proxy printing function) to enable a print job to be performed based on print data of an input print instruction even when the image forming apparatus is operated by a proxy user other than an owner user originating the print instruction. According to this proxy printing function, after a president inputs a print instruction on his client PC, a secretary of the president may operate the image forming apparatus to perform a print job based on print data of the print instruction even when the secretary logs in to the image forming apparatus by using his account.

### CITATION LIST

### Patent Literature

PTL 1: Japanese Laid-Open Patent Publication No. 2012-248006

### SUMMARY OF INVENTION

### Technical Problem

In the above-described proxy printing function, print data is transmitted from a client PC (A) of the owner user such as a president to a client PC (B) of the proxy user such as a secretary, and the print data is stored in the proxy user's client PC (B). When the proxy user inputs his user ID to the image forming apparatus, a list of print data items stored in the client PC (B) of that user ID will be displayed to prompt the proxy user to input a selection of a printing target from the list. This allows the proxy user to perform a print job of the print data requested by the owner user.

In such a mechanism, however, storage areas of the proxy user's client PC (B) are used as storage locations of the print data and the storage areas must be consumed regardless of the intention of the proxy user.

In one aspect, the present disclosure provides an information processing system capable of reducing the consumption of storage areas of an information processing apparatus used by a proxy user in charge of outputting data.

### Solution of Invention

In one embodiment, the present disclosure provides an information processing system including an information processing apparatus and an apparatus which are connected to each other via a network, the information processing apparatus including a first processor configured to implement a storage unit configured to store data which is to be output by the apparatus, the data being associated with one or more user identifiers of one or more users different from a user of the information processing apparatus, and a first transmission unit configured to transmit to the apparatus the data associated with a user identifier received from the apparatus, and stored by the storage unit, the apparatus including a second processor configured to implement a second transmission unit configured to transmit a user identifier of a user of the apparatus to the information processing apparatus, a reception unit configured to receive from the information processing apparatus the data stored by the storage unit and associated with the user identifier transmitted by the second transmission unit, and an output unit configured to output the data received by the reception unit.

### Advantageous Effects of Invention

The information processing system according to the present disclosure is capable of reducing the consumption of storage areas of the information processing apparatus used by the proxy user in charge of outputting the data.

The object and advantages of the invention will be realized and attained by means of the elements and combinations particularly pointed out in the claims. It is to be understood that both the foregoing general description and the following detailed description are exemplary and explanatory and are not restrictive of the invention as claimed.

### BRIEF DESCRIPTION OF DRAWINGS

FIG. 1 is a diagram illustrating an example of a printing system according to a first embodiment.

FIG. 2 is a diagram illustrating a hardware configuration of a client terminal according to the first embodiment.

FIG. 3 is a diagram illustrating a hardware configuration of an image forming apparatus according to the first embodiment.

FIG. 4 is a diagram illustrating a functional configuration of the printing system according to the first embodiment.

FIG. 5 is a flowchart for explaining a process performed by the client terminal in response to a print instruction.

FIG. 6 is a diagram illustrating an example of a job information storage unit.

FIG. 7 is a diagram illustrating an example of a proxy information storage unit.

FIG. 8 is a flowchart for explaining a process performed by the image forming apparatus according to an input operation by a user.

FIG. 9 is a diagram illustrating an example of a user information storage unit.

FIG. 10 is a flowchart for explaining a process performed by the client terminal in response to a job list request.

FIG. 11 is a flowchart for explaining a process performed by the client terminal in response to a print data request.

FIG. 12 is a flowchart for explaining a process performed by the client terminal in response to reception of printing result information.

FIG. 13 is a diagram illustrating an example of a renewed job information storage unit.

FIG. 14 is a flowchart for explaining a process performed by the client terminal according to a second embodiment in response to reception of printing result information.

FIG. 15 is a diagram illustrating an example of a renewed job information storage unit according to the second embodiment.

FIG. 16 is a flowchart for explaining a process performed by the client terminal according to a third embodiment in response to reception of printing result information.

FIG. 17 is a diagram illustrating an example of a renewed job information storage unit according to the third embodiment.

### DESCRIPTION OF EMBODIMENTS

A description will be given of embodiments with reference to the accompanying drawings.

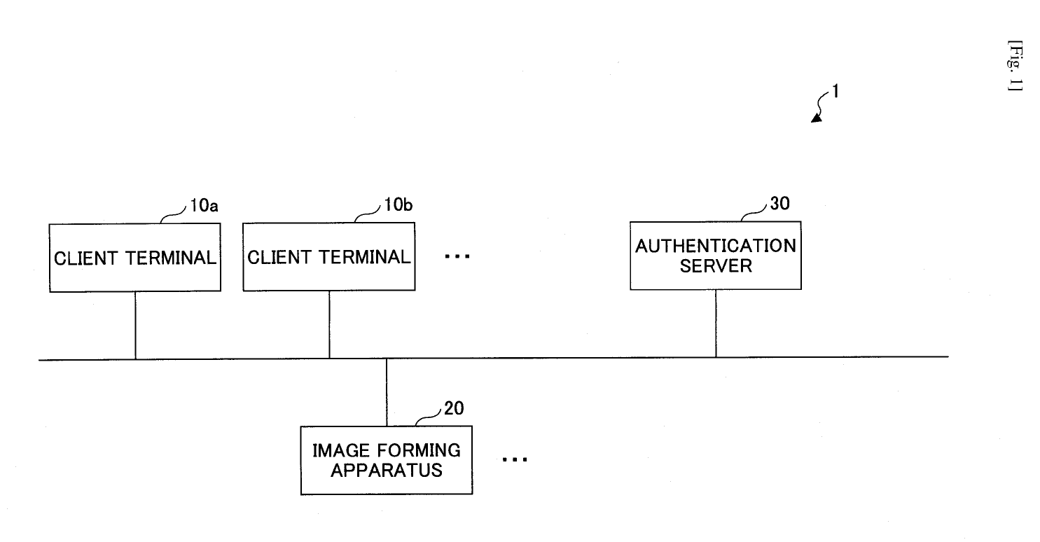

FIG. 1 is a diagram illustrating a configuration of a printing system 1 according to a first embodiment. As illustrated in FIG. 1, the printing system 1 includes one or more client terminals 10, such as a client terminal 10a and a client terminal 10b, an authentication server 30, and one or more image forming apparatuses 20. These devices of the printing system 1 are interconnected by an in-company network such as a local area network (LAN) and configured to communicate with one another.

The client terminal 10 may be an information processing apparatus which is operated directly by a user of the printing system 1. Examples of the client terminal 10 may include a personal computer (PC), a smart phone, a tablet terminal, and a personal digital assistant (PDA). A user may input to the client terminal 10 a print instruction in which arbitrary data is designated as a printing target. In response to the print instruction, the client terminal 10 generates print data based on the data designated as the printing target, and stores the print data in the client terminal 10. Note that the print data refers to data used for drawing of a print image in a print job, such as data in page description language (PDL) form.

In the present embodiment, a user (proxy) operating the image forming apparatus 20 to perform printing, instead of another user (owner) originating a print instruction, may be designated. Once the proxy is designated, a user ID of the proxy is associated with the print data stored in the client terminal 10. In the following, a print job in which a proxy is designated will be called proxy printing.

The authentication server 30 may be a computer configured to manage user IDs and passwords of users of the printing system 1, address information of client terminals 10 of the users, and information to associate an owner with a proxy in proxy printing. The information to associate the owner with the proxy in the proxy printing may be information indicating which user identifier is designated as the proxy user and which user identifier is designated as the owner user in connection with the proxy user. This information is transmitted from the client terminal 10 to which the proxy printing instruction is input.

The image forming apparatus 20 may be an apparatus having a print function such as a printer or a multifunction peripheral (MFP). In response to an input operation by a user, the image forming apparatus 20 transmits to the client terminal 10 of the user a request for acquiring a list of job information (or bibliographic information) items of print data associated with a user ID of the user. The image forming apparatus 20 acquires, from the client terminal 10, print data generated based on a job information item selected by the user from the list of job information items obtained in response to the request, and performs a print job based on the acquired print data. Note that, if the user of the image forming apparatus 20 is a proxy of a different user, the image forming apparatus 20 may acquire a list of job information items and print data also from the client terminal 10 of the different user.

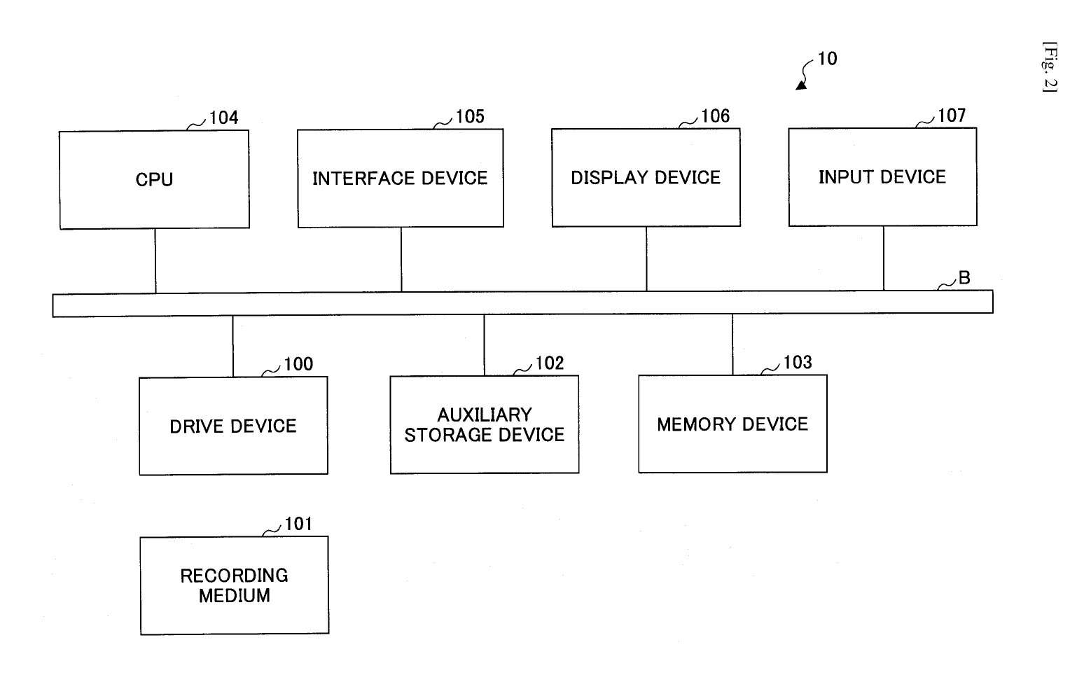

FIG. 2 is a diagram illustrating a hardware configuration of the client terminal 10 according to the first embodiment. As illustrated in FIG. 2, the client terminal 10 includes a drive device 100, an auxiliary storage device 102, a memory device 103, a central processing unit (CPU) 104, an interface device 105, a display device 106, and an input device 107. These elements and devices of the client terminal 10 are inter-connected by a bus B. The CPU 104 may be a processor configured to control overall operations of the client terminal 10.

Programs which when executed by the processor of the client terminal 10 cause the processor to perform various processes (which will be described later) may be installed in the client terminal 10 using a recording medium 101 such as a compact disc read-only memory (CD-ROM). If the recording medium 101 in which the programs are stored is placed in the drive device 100, the programs from the recording medium 101 are installed in the auxiliary storage device 102 through the drive device 100. However, the installation of the programs using the recording medium 101 is not necessarily required and the programs may be downloaded to the client terminal 10 from another computer via the network. The auxiliary storage device 102 is configured to store necessary files and data in addition to the programs installed therein.

The memory device 103 is configured to read a program from the auxiliary storage device 102 in response to a program activation instruction from the CPU 104 and store the program in the memory device 103. The CPU 104 is configured to implement the functions of the client terminal 10 based on the programs stored in the memory device 103. The interface device 105 is utilized as an interface for connecting with the network. The display device 106 is configured to display graphical user interfaces (GUIs) based on the programs. The input device 107 includes a keyboard and a mouse and is utilized to input various operation instructions.

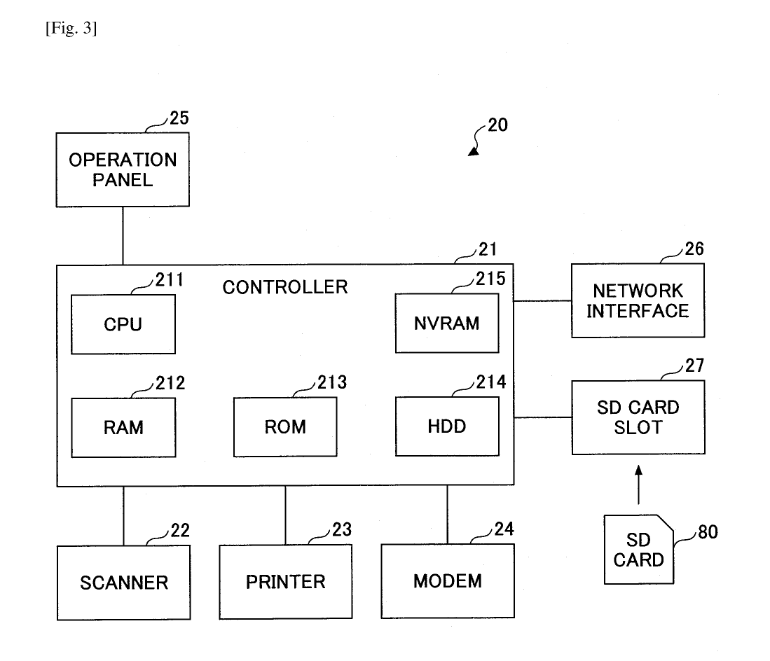

FIG. 3 is a diagram illustrating a hardware configuration of the image forming apparatus 20 according to the first embodiment. As illustrated in FIG. 3, the image forming apparatus 20 includes a controller 21, a scanner 22, a printer 23, a modem 24, an operation panel 25, a network interface 26, and a secure digital (SD) card slot 27.

The controller 21 includes a CPU 211, a random access memory (RAM) 212, a read-only memory (ROM) 213, a hard disk drive (HDD) 214, and a non-volatile random access memory (NVRAM) 215. The ROM 213 is configured to store programs and data used by the programs. The RAM 212 is utilized to provide a storage area for loading a program and provide a work area for the loaded program. The CPU 211 is configured to implement the functions of the image forming apparatus 20 based on the programs stored in the RAM 212. The HDD 214 is configured to store the programs and various data utilized by the programs. The NVRAM 215 is configured to store setting information items.

The scanner 22 is a hardware unit (image reading unit) configured to read image data from a document. The printer 23 is a hardware unit (printing unit) configured to print the print data on a print sheet. The modem 24 is a hardware unit configured to connect the image forming apparatus 20 to a telephone line. The modem 24 is utilized to transmit and receive the image data by fax communication. The operation panel 25 is a hardware unit including an input unit with buttons configured to receive an input operation by a user, and a display unit such as a liquid crystal panel. The liquid crystal panel may have a touch panel function. In this case, the liquid crystal panel may also have a function of the input unit. The network interface 26 is a hardware unit configured to connect the image forming apparatus 20 to a wired or wireless network such as a LAN. The SD card slot 27 is utilized to read programs stored in a SD card 80. Namely, in the image forming apparatus 20, not only the programs stored in the ROM 213 but also the programs stored in the SD card 80 may be loaded to the RAM 212 and such programs may be executed by the CPU 211. Note that another recording medium such as a CD-ROM or a USB (universal serial bus) memory may be utilized instead of the SD card 80. Namely, the kind of a recording medium equivalent to the SD card 80 is not limited to a predetermined kind. In such a case, the SD card slot 27 may be replaced by a hardware unit conforming to the kind of the recording medium utilized.

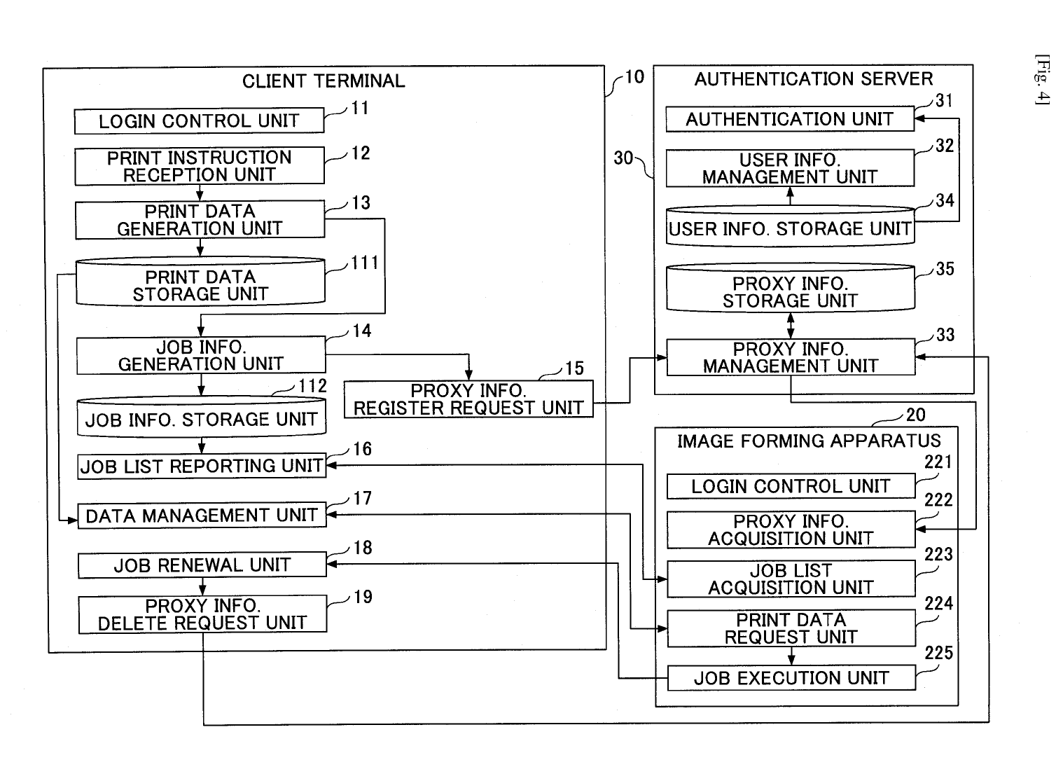

FIG. 4 is a diagram illustrating a functional configuration of the printing system according to the first embodiment. As illustrated in FIG. 4, the client terminal 10 includes a login control unit 11, a print instruction reception unit 12, a print data generation unit 13, a job information generation unit 14, a proxy information register request unit 15, a job list reporting unit 16, a data management unit 17, a job renewal unit 18, and a proxy information delete request unit 19. These units represent functions and units implemented by any of the elements and devices of the client terminal 10 illustrated in FIG. 2, which are activated by instructions from the CPU 104 based on the programs stored in the memory device 103. The client terminal 10 further includes a print data storage unit 111 and a job information storage unit 112. These storage units are implemented by using the auxiliary storage device 102 of the client terminal 10.

The login control unit 11 is configured to request the authentication server 30 to perform authentication of a login user based on a user ID and a password input to the client terminal 10 by the login user. When the authenticity of the login user is successfully verified by the authentication server 30, the login control unit 11 is configured to identify the login user by the input user ID.

The print instruction reception unit 12 is configured to receive from the user a print instruction to output any of data items stored in the client terminal 10. Further, when receiving a print instruction, a designation of a proxy may be also received.

The print data generation unit 13 is configured to generate print data based on the data designated as a printing target in the print instruction. The generated print data is stored in the print data storage unit 111. The job information generation unit 14 is configured to generate a job information item related to the print data generated in response to the print instruction. This job information item includes an identifier (job ID) of an individual print request or an individual print job, an identifier (user ID) of a user (owner) originating the print instruction, and information indicating a storage location of the print data. When a proxy is designated in the print instruction, a user ID of the proxy is also included in the job information item. The generated job information item is stored in the job information storage unit 112.

The proxy information register request unit 15 is configured to transmit, when one or more proxies are designated in the print instruction, a register request for registering information to associate a user ID of the owner (owner ID) with user IDs of the proxies (proxy IDs) to the authentication server 30.

The job list reporting unit 16 is configured to receive a job list request from the image forming apparatus 20 operated by the user, and to acquire from the job information storage unit 112 a list of job information items (job list) of the owner ID or the proxy ID which accords with the user ID included in the job list request. The job list reporting unit 16 is further configured to send the job list of the acquired job information items to the image forming apparatus 20 originating the job list request.

The data management unit 17 is configured to acquire from the print data storage unit 111 print data in response to reception of a print data request corresponding to a job information item selected from the job information items of the job list by the user on the image forming apparatus 20. The data management unit 17 is further configured to send the acquired print data to the image forming apparatus 20 originating the print data request.

The job renewal unit 18 is configured to receive information indicating a result of execution of the print job (printing result information) which is sent by the image forming apparatus 20 after the print job is executed by the image forming apparatus 20. The job renewal unit 18 is configured to delete the job information item stored in the job information storage unit 112 and related to the print data of the print job when the printing result information indicates a success of the print job executed, and to delete the corresponding print data in the print data storage unit 111.

The proxy information delete request unit 19 is configured to transmit to the authentication server 30 a delete request for deleting the information to associate the owner ID included in the job information item with the proxy ID after the job information item related to the proxy printing is deleted.

As illustrated in FIG. 4, the authentication server 30 includes an authentication unit 31, a user information management unit 32, and a proxy information management unit 33. These units represent functions and units implemented by any of the elements and devices of the authentication server 30 (which are similar to the elements and devices illustrated in FIG. 2), which are activated by instructions from a CPU (a processor) of the authentication server 30 based on programs stored in a memory device of the authentication server 30. The authentication server 30 further includes a user information storage unit 34 and a proxy information storage unit 35. These storage units are implemented by using an auxiliary storage device of the authentication server 30 or a storage device connectable to the authentication server 30 via the network.

The authentication unit 31 is configured to perform authentication based on a user ID and a password which are included in an authentication request from the client terminal 10 or the image forming apparatus 20. The user information management unit 32 is configured to manage user information stored in the user information storage unit 34. For example, the user information management unit 32 receives a user information request in which a user ID is designated, and sends a user information item associated with the user ID in response to the request. The user information storage unit 34 is configured to store user information items each associated with one of users authorized to utilize the printing system 1. Each user information item includes a user ID, a password, and a terminal address of the client terminal 10 used by the user.

The proxy information management unit 33 is configured to receive from the client terminal 10 a register request for registering information to associate the owner ID with the proxy ID, and store the information indicating the association between the owner ID and the proxy ID into the proxy information storage unit 35 in response to the received request. The proxy information management unit 33 is configured to receive from the client terminal 10 a delete request for deleting information to associate the owner ID with the proxy ID, and delete the information indicating the association between the owner ID and the proxy ID in the proxy information storage unit 35 in response to the received request. Further, the proxy information management unit 33 is configured to receive from the image forming apparatus 20 an acquire request for acquiring an owner ID associated with the proxy ID which accords with the user ID included in the acquire request, and send to the image forming apparatus 20 the owner ID obtained by making reference to the stored information in the proxy information storage unit 35.

As illustrated in FIG. 4, the image forming apparatus 20 includes a login control unit 221, a proxy information acquisition unit 222, a job list acquisition unit 223, a print data request unit 224, and a job execution unit 225. These units represent functions and units implemented by any of the elements and devices of the image forming apparatus 20 illustrated in FIG. 3, which are activated by instructions from the CPU 211 of the image forming apparatus 20 based on one or more programs stored in the RAM 212 of the image forming apparatus 20.

The login control unit 221 is configured to send an authentication request to the authentication server 30 so that the authentication server 30 is requested to perform authentication of a login user based on a user ID and a password which are input to the image forming apparatus 20 by the user. When the authenticity of the login user is successfully verified by the authentication server 30, the login control unit 221 is configured to identify the login user based on the input user ID.

The proxy information acquisition unit 222 is configured to acquire from the authentication server 30 an owner ID associated with the proxy ID which accords with the user ID of the login user. Namely, the proxy information acquisition unit 222 acquires the user ID of another user (owner) who has requested the login user to perform the proxy printing.

The job list acquisition unit 223 is configured to acquire a job list from the client terminal 10 of the login user. Further, when the owner ID is acquired by the proxy information acquisition unit 222, the job list acquisition unit 223 is configured to acquire from the client terminal 10 of the owner ID a job list including the job information in which the user ID of the login user accords with the proxy ID.

The print data request unit 224 is configured to acquire print data of the job information item from the client terminal 10 which accords with the sender terminal having transmitted the job information item selected by the user from the job list displayed on the operation panel of the image forming apparatus 20.

The job execution unit 225 is configured to control the performance of the print job based on the print data acquired by the print data request unit 224.

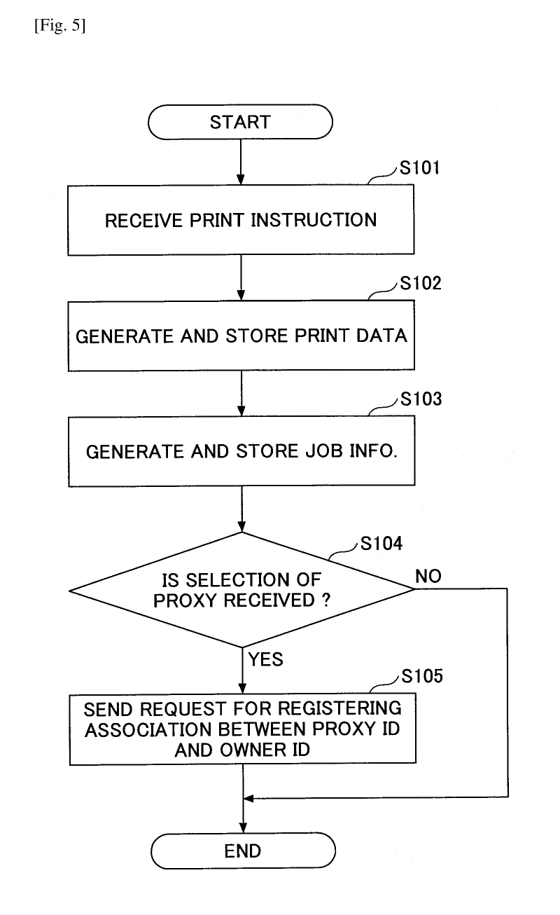

Next, several processes performed by the printing system 1 according to the first embodiment will be described. FIG. 5 is a flowchart for explaining a process performed by the client terminal 10 in response to a print instruction.

As illustrated in FIG. 5, in step S101, the print instruction reception unit 12 receives a print instruction from a user. In this print instruction, data of a printing target is designated by the user, and if needed, a proxy ID is also designated by the user. Two or more proxy IDs may be designated.

Subsequently, in step S102, the print data generation unit 13 generates print data based on the data designated as the printing target and stores the generated print data in the print data storage unit 111. Subsequently, in step S103, the job information generation unit 14 generates a job information item based on the print data generated at step S102 and stores the generated job information item in the job information storage unit 112.

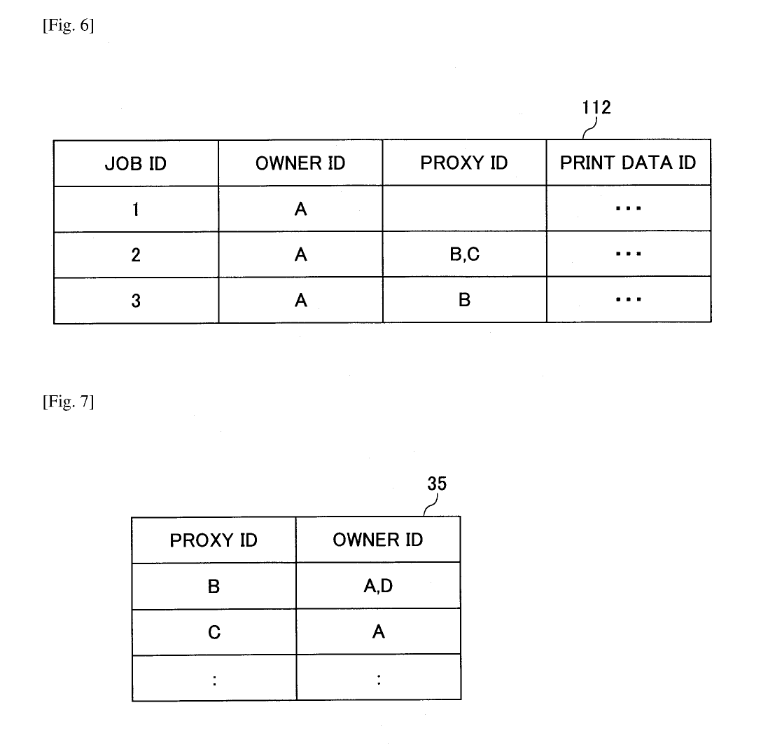

FIG. 6 is a diagram illustrating an example of the job information storage unit 112. As illustrated in FIG. 6, in the job information storage unit 112, a job ID of each print data is associated with an owner ID, a proxy ID, and a print data ID, and the association between these IDs is stored.

The job ID is a job identifier assigned to each of the job information items. For example, the job ID may be generated at step S103 by the job information generation unit 14. The owner ID is a user ID of the owner having input the print instruction. Namely, the owner ID is a user ID of the login user of the client terminal 10. The proxy ID is a user ID of a user being designated as a proxy in the print instruction. Namely, the proxy ID is a user ID of the user to perform the proxy printing according to the print instruction. The print data ID is an identifier of the print data generated according to the print instruction. The print data ID may be any type of information if the storage location of the print data in the print data storage unit 111 is uniquely specified by the information. For example, the print data ID may be a file path name or a uniform resource locator (URL). The print data ID is included in the job information item, and the print data of the print data ID is associated with other information items included in the job information item. Note that the print data ID is identified at step S102.

Subsequently, in step S104, the proxy information register request unit 15 determines whether the proxy ID is designated in the print instruction. When the proxy ID is designated (YES in S104), the proxy information register request unit 15 in step S105 transmits to the authentication server 30 a register request for registering information to associate the user ID (owner ID) of the login user of the client terminal 10 with the proxy ID designated in the print instruction.

When the register request is received, the proxy information management unit 33 of the authentication server 30 associates the owner ID and the proxy ID included in the register request and stores the association between the owner ID and the proxy IDS in the proxy information storage unit 35.

FIG. 7 is a diagram illustrating an example of the proxy information storage unit 35. As illustrated in FIG. 7, in the proxy information storage unit 35, a proxy ID of each of proxies is associated with an owner ID of a corresponding owner originating the proxy printing to the proxy, and the association between the proxy IDs and the owner IDs is stored. The proxy information management unit 33 is configured to register the owner ID included in the register request for each of the proxy IDs included in the register request. The owner ID is associated with the proxy ID, and the proxy ID is associated with the address information of the client terminal 10 of the owner, whose owner ID accords with the user ID associated with the corresponding terminal address in the user information storage unit 34.

Note that the address information of the client terminal 10 of an owner for each proxy ID may be stored in the proxy information storage unit 35. In this case, at step S105, the proxy information register request unit 15 may transmit a register request for registering information to associate the proxy ID and the address information of the client terminal 10. Namely, the proxy ID may be associated directly with the address information of the client terminal 10 of the owner.

Further, in the above example, the proxy ID is designated in the print instruction. When a certain user performs the proxy printing at any times, a predetermined proxy ID may be stored beforehand in the client terminal 10 of the user or the authentication server 30. In this case, the pre-stored proxy ID may be included in the job information item generated at step S103.

After the process illustrated in FIG. 5 is performed, the proxy may move to the image forming apparatus 20 and operate the image forming apparatus 20 to perform the print job based on the print data designated as the printing target in the print instruction.

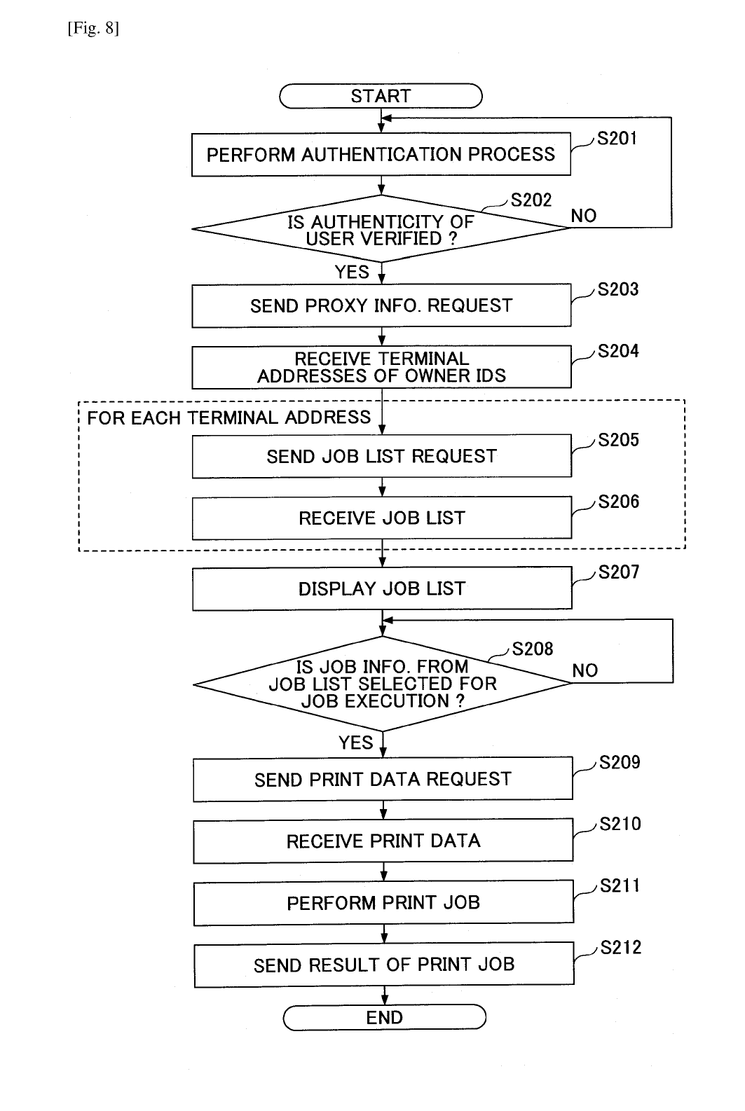

FIG. 8 is a flowchart for explaining a process performed by the image forming apparatus 20 according to an input operation by a user.

For example, a login screen is displayed on the operation panel 25 of the image forming apparatus 20. When authentication information such as a user ID and a password is input to the login screen by the user, the login control unit 221 performs an authentication process based on the authentication information (S201). For example, an authentication request including the authentication information is transmitted from the login control unit 221 to the authentication server 30. In response to the authentication request, the authentication unit 31 of the authentication server 30 performs an authentication process in which the authentication information included in the authentication request is verified with a user ID and a password included in a corresponding user information item stored in the user information storage unit 34.

FIG. 9 is a diagram illustrating an example of the user information storage unit 34. As illustrated in FIG. 9, in the user information storage unit 34, a user ID for each user is associated with a password and a terminal address, and user information items, each including the user ID, the password, and the terminal address, are stored. This terminal address may be address information of the client terminal 10 utilized by the user. For example, an IP address of the client terminal 10 may be a value of the terminal address.

Subsequently, the authentication server 30 sends to the login control unit 221 a result of the authentication process. When the authentication result indicates that the authentication information is successfully verified (YES in S202), the proxy information acquisition unit 222 transmits to the authentication server 30 a proxy information request including the user ID (the login user ID) related to the success of the authentication process (S203). The proxy information management unit 33 of the authentication server 30 sends to the proxy information acquisition unit 222 an owner ID associated with the proxy ID which accords with the user ID included in the proxy information request. When two or more owner IDs associated with the proxy ID are registered, all the owner IDs are sent from the authentication server 30 to the proxy information acquisition unit 222.

Subsequently, the job list acquisition unit 223 acquires from the authentication server 30 the terminal address associated with the login user ID, and the terminal address associated with each of the owner IDs acquired in step S203 (S204). Namely, the terminal addresses associated with the user IDs and stored in the user information storage unit 34 are acquired.

Note that, when the proxy ID is associated directly with the terminal address of the client terminal 10 of the owner in the proxy information storage unit 35, the terminal address of each owner is acquired in step S203. In this case, it is adequate that the terminal address of the client terminal 10 of the login user of the image forming apparatus 20 is acquired in step S204.

Subsequently, the processing of steps S205 and S206 is performed repeatedly for each of the terminal addresses acquired. In step S205, the job list acquisition unit 223 transmits to each of the client terminals 10 of the acquired terminal addresses a job list request for acquiring a job list including job information items with the owner ID or the proxy ID which accords with the login user ID.

Note that the job list acquisition unit 223 may be configured to transmit in step S205 the job list request to all the client terminals 10. All the client terminals 10 may refer to all the client terminals 10 of the terminal addresses stored in the user information storage unit 34 of the authentication server 30, or may refer to all the client terminals 10 in the list of terminal addresses registered beforehand in the image forming apparatus 20. In this case, the processing of step S204 may be skipped, and the processing of steps S104 and S105 illustrated in FIG. 5 may also be skipped. Namely, it is not necessary to register the association between the owners and the proxies in the authentication server 30. However, if the association between the owners and the proxies is registered in the authentication server 30, the job list acquisition terminals are restricted based on the association between the owners and the proxies, and the processing load and the communication load in step S205 may be reduced.

In step S206, the job list acquisition unit 223 receives a job list from each of the client terminals 10 which are the destination terminals of the job list request. Subsequently, the job list acquisition unit 223 displays the received job list on the operation panel 25 of the image forming apparatus 20 (S207). When two or more job lists are received from the client terminals 10, an integrated result of the job lists may be displayed.

When one or more job information items are selected from the displayed job list and a print job execution instruction is input by the user (YES in S208), the print data request unit 224 sends a print data request including job IDs of the selected job information items to the client terminal 10 which is the job information transmitting source terminal (S209). The print data request unit 224 receives the print data sent by the client terminal 10 in response to the print data request (S210). Subsequently, the job execution unit 225 controls the image forming apparatus 20 to perform the print job based on the received print data (S211). Subsequently, the job execution unit 225 transmits printing result information indicating a result of the print job performed to the client terminal 10 which is the print data transmitting source terminal (S212). For example, the printing result information includes the job ID of the print job, and information indicating the success or failure of the print job.

Note that the job list acquisition unit 223 may be configured to display a list of the owner IDs acquired at step S203 on the operation panel 25, and receive from the user a selected owner ID to perform the proxy printing. In this case, in the processing of step S204 and subsequent steps, the owner ID selected from the owner IDs acquired at step S203 may be taken as a processing target.

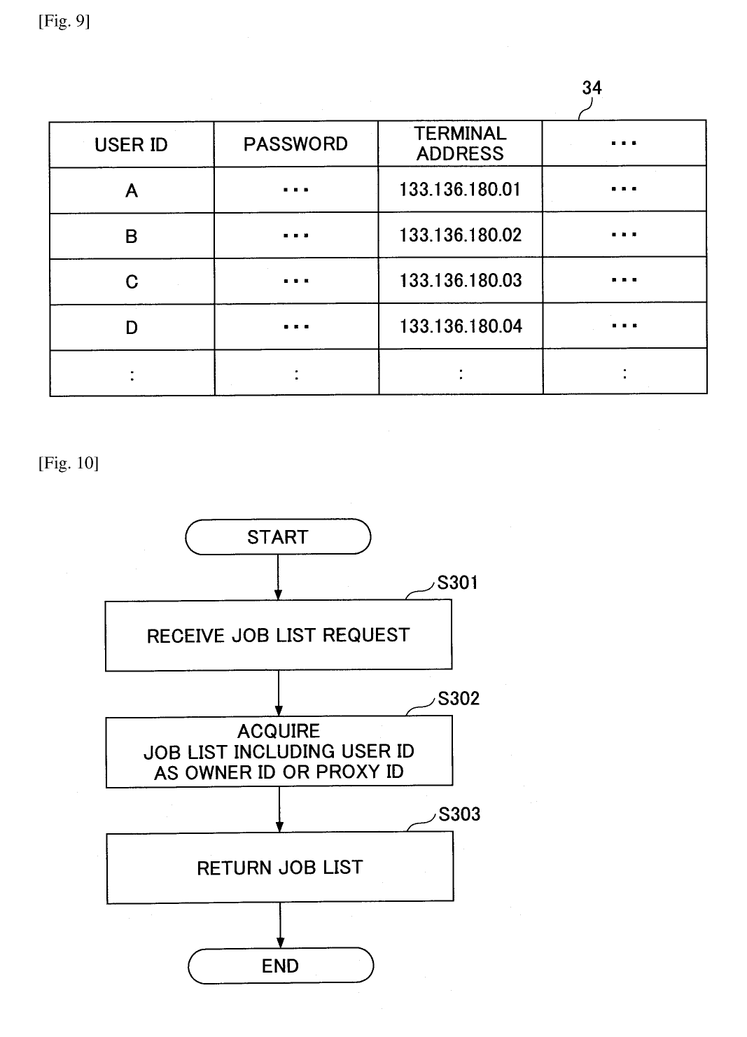

Next, a process performed by the client terminal 10 in response to a job list request received from the image forming apparatus 20 at the step S205 above will be described. FIG. 10 is a flowchart for explaining the process performed by the client terminal 10 in response to the job list request.

In step S301, the job list reporting unit 16 receives the job list request. Subsequently, the job list reporting unit 16 acquires from the job information storage unit 112 job information items associated with the owner ID or the proxy ID which accords with the user ID included in the job list request (S302). Subsequently, the job list reporting unit 16 sends a job list including the acquired job information items to the image forming apparatus 20 which is the job list request transmitting source terminal (S303).

For example, when the client terminal 10 to perform the process illustrated in FIG. 10 is identical to the client terminal 10 of the login user of the image forming apparatus 20, the job information item including the user ID of the login user as the owner ID will be sent to the image forming apparatus 20. On the other hand, when the client terminal 10 to perform the process illustrated in FIG. 10 is different from the client terminal 10 of the login user of the image forming apparatus 20, the job information item including the user ID of the login user as the proxy ID will be sent to the image forming apparatus 20.

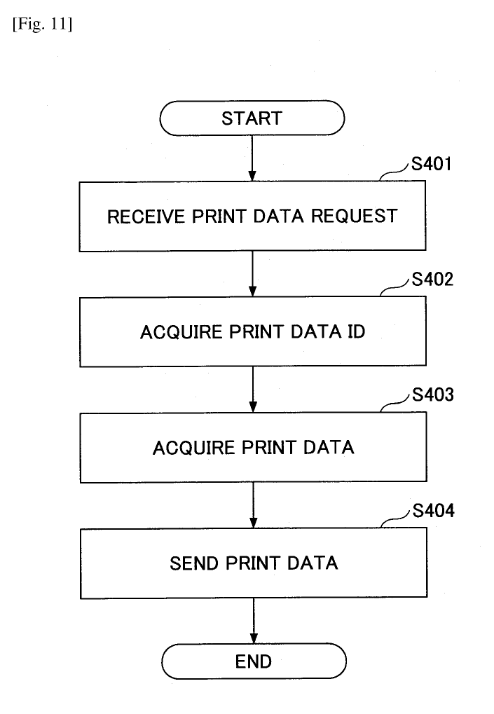

Next, a process performed by the client terminal 10 in response to a print data request received from the image forming apparatus 20 at the step S209 above will be described. FIG. 11 is a flowchart for explaining the process performed by the client terminal 10 in response to the print data request.

In step S401, the data management unit 17 receives the print data request. The print data request includes a job ID. In the following, this job ID is called a target job ID.

Subsequently, the data management unit 17 acquires a print data ID included in a job information item of the target job ID from among the job information items stored in the job information storage unit 112 (S402). As a result, the print data ID (target print data ID) of the print data as the acquisition target is identified.

Subsequently, the data management unit 17 acquires the print data of the target print data ID from the print data storage unit 111 (S403). Subsequently, the print data transmission unit sends the acquired print data to the image forming apparatus 20 which is the print data request transmitting source terminal (S404).

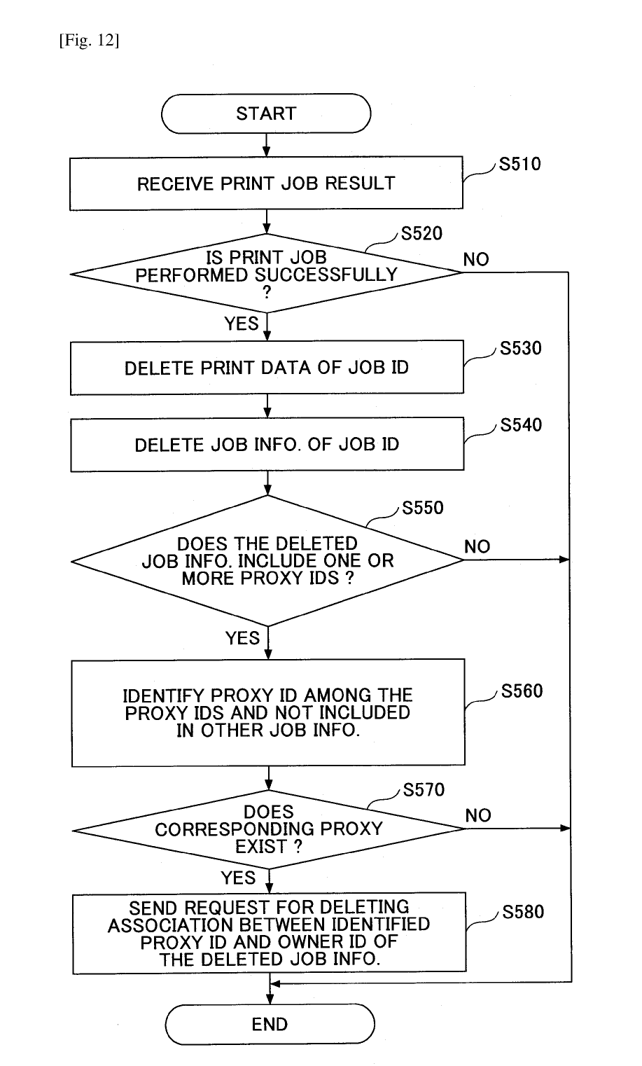

Next, a process performed by the client terminal 10 according to the first embodiment in response to reception of printing result information from the image forming apparatus 20 at the step S212 above will be described. FIG. 12 is a flowchart for explaining the process performed by the client terminal 10 in response to reception of the printing result information.

The job renewal unit 18 receives the printing result information (S510). Subsequently, the job renewal unit 18 determines whether the printing result information indicates the success of the print job (S520). When the printing result information indicates the failure of the print job (NO in S520), the process illustrated in FIG. 12 is terminated. When the printing result information indicates the success of the print job (YES in S520), the job renewal unit 18 deletes the print data corresponding to the job ID included in the printing result information from the print data storage unit 111 (S530). The print data corresponding to the job ID refers to the print data of the print data ID included in the job information item including the job ID. Subsequently, the job renewal unit 18 deletes the job information item corresponding to the job ID included in the printing result information from the job information storage unit 112 (S540). The job information item corresponding to the job ID refers to the job information item including the job ID.

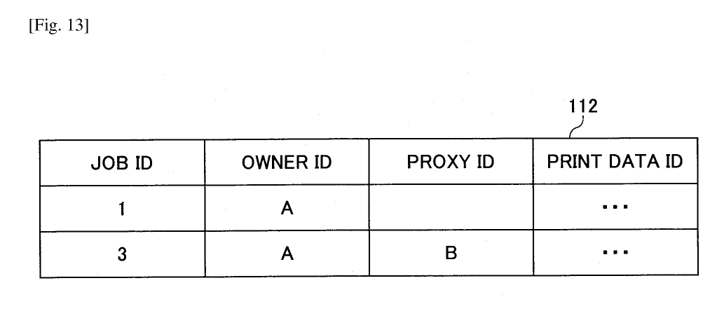

FIG. 13 is a diagram illustrating an example of a renewed job information storage unit 112. In the example illustrated in FIG. 13, the job information storage unit 112 is renewed after the printing result information indicating the success of a print job of a job ID “2” is received. In this example, the job information item with the job ID “2” is deleted from the job information storage unit 112 by the job renewal unit 18.

In the process illustrated in FIG. 12, after the step S540 is performed, the proxy information delete request unit 19 determines whether one or more proxy IDs are included in the deleted job information item (S550). Note that, in order to enable the determination at step S550, when any proxy ID is included in the job information item to be deleted, the proxy ID is to be saved before deleting the job information item. When no proxy ID is included in the deleted job information item (NO in S550), the process illustrated in FIG. 12 is terminated. When one or more proxy IDs are included in the deleted job information item (YES in S550), the proxy information delete request unit 19 identifies a proxy ID among the one or more proxy IDs which is not included in any of other job information items which are still stored in the job information storage unit 112 (step S560). For example, in the job information storage unit 112 illustrated in FIG. 6, proxy IDs “B” and “C” are included in the job information item with the job ID “2”, while a proxy ID “C” is not included in the job information item with the job ID “1” and the job information item with the job ID “3”. Hence, in this case, the proxy ID “C” is identified at step 5560 as an applicable proxy ID.

When any applicable proxy ID is not identified (NO in S570), the process illustrated in FIG. 12 is terminated. When one or more applicable proxy IDs are identified (YES in S570), the proxy information delete request unit 19 transmits to the authentication server 30 a delete request for deleting the information to associate the proxy IDs with the owner ID of the deleted job information item (S580). The delete request transmitted includes the identified proxy IDs and the owner ID. Specifically, in response to the delete request, the proxy information management unit 33 of the authentication server 30 deletes the owner ID included in the delete request from the records of the proxy information items stored in the proxy information storage unit 35 and including the proxy ID which accords with any of the proxy IDs included in the delete request. As a result, the association between the identified proxy IDs and the owner ID is canceled. Hence, after the process illustrated in FIG. 12 is performed, even if a user of any of the identified proxy IDs logs in to the image forming apparatus 20, the job list displayed does not include the job information item associated with the owner ID.

As described above, according to the first embodiment, the proxy printing may be performed without storing the print data in the client terminal 10 of a proxy user. Hence, according to the first embodiment, the consumption of storage areas of the information processing apparatus (the client terminal 10) used by the proxy user in change of outputting the print data may be reduced.

Further, according to the first embodiment, even when two or more proxies are designated in the print instruction, the print data is stored in a single storage location. Hence, according to the first embodiment, when two or more proxies are designated, the consumption of storage areas of the entire information processing system may be reduced.

Further, the print data is stored in the single storage location, and the process to delete the print data after the print job of the print data is performed may be simplified. Namely, if the print data is stored in each of the client terminals 10 of the proxies, then the process to delete the print data must be performed on the client terminals 10 of the proxies. In this case, as the number of the proxies increases, the possibility that the process to delete the print data fails due to an inactive state of any of the client terminals 10 increases. According to the first embodiment, the process to delete the print data is performed on a single client terminal 10, and the possibility of the failure of the process to delete the print data may be reduced.

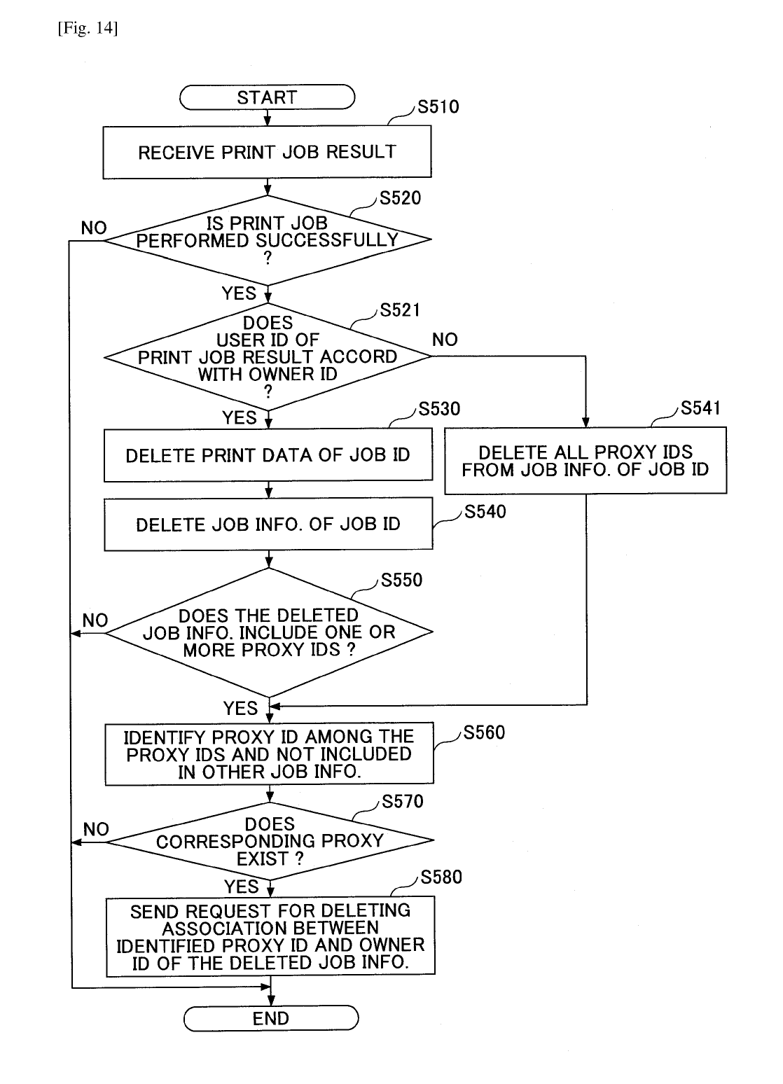

Next, FIG. 14 is a flowchart for explaining a process performed by the client terminal 10 according to a second embodiment in response to reception of the printing result information. In FIG. 14, the steps which are essentially the same as corresponding steps in the process illustrated in FIG. 12 are designated by the same reference numerals, and a description thereof will be omitted.

In the second embodiment, the printing result information received at step S510 includes a user ID of a user inputting the print job execution instruction in the image forming apparatus 20 (i.e., a user ID of the login user at the time of execution of the print job).

As illustrated in FIG. 14, in the second embodiment, when the printing result information indicates the success of the print job at the step S520 above, step S521 is performed. In step S521, the job renewal unit 18 determines whether the user ID included in the printing result information accords with the owner ID of the job information item stored in the job information storage unit 112 and corresponding to the job ID included in the printing result information. Namely, it is determined whether the image forming apparatus 20 is operated by the owner or by the proxy. When the user ID accords with the owner ID (YES in S521), the processing of steps S530 to S580 is performed similar to the first embodiment described above. When the user ID does not accord with the owner ID (NO in S521), the job renewal unit 18 deletes all the proxy IDs from the job information item stored in the job information storage unit 112 and corresponding to the job ID included in printing result information (S541).

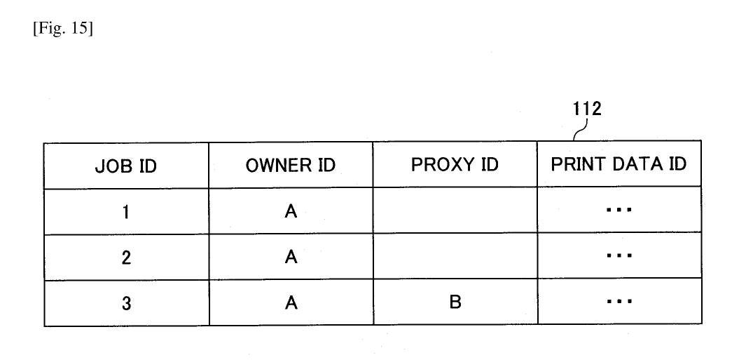

FIG. 15 is a diagram illustrating an example of a renewed job information storage unit 112 according to the second embodiment. In the example illustrated in FIG. 15, the job information storage unit 112 is renewed after the printing result information indicating the success of the print job of the job ID “2” is received similar to FIG. 13. In this example, all the proxy IDs (“B” and “C”) of the job information item with the job ID “2” are deleted from the job information storage unit 112 by the job renewal unit 18 as illustrated in FIG. 15.

In the second embodiment, the print data with which the print job is successfully performed is not deleted, but the association between the owner ID and the proxy IDs is canceled. Hence, in the second embodiment, even when the printing of the print data is performed by the proxy, the owner is able to perform the print job again.

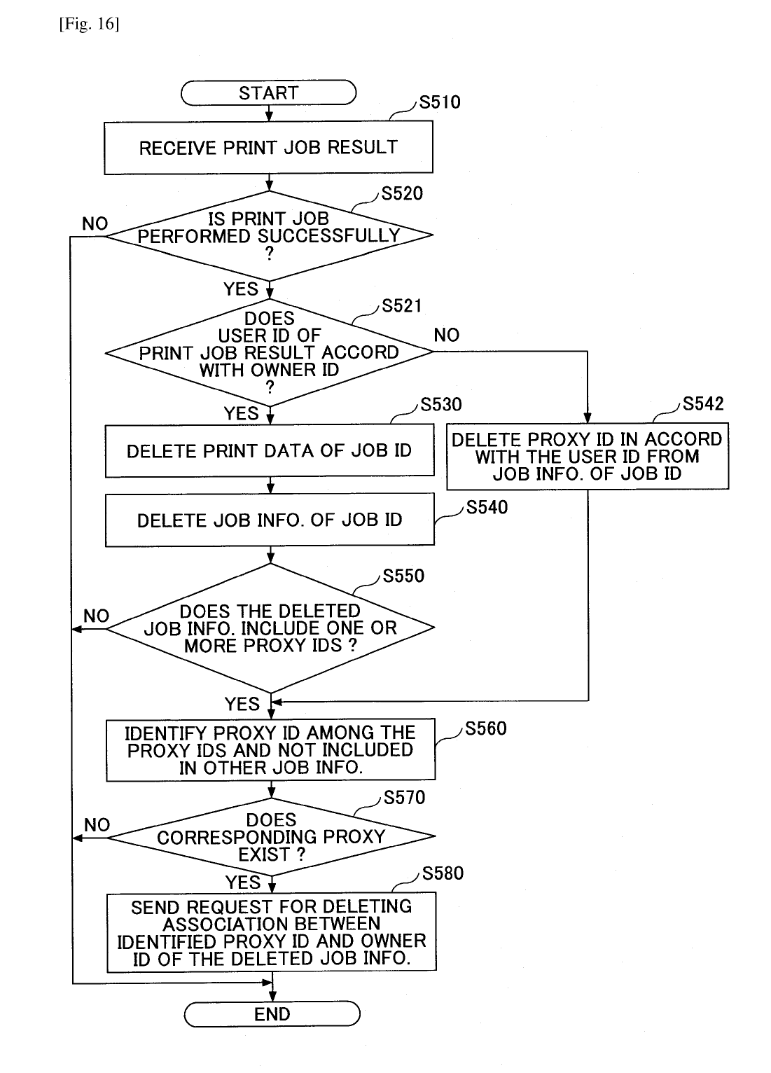

Next, FIG. 16 is a flowchart for explaining a process performed by the client terminal 10 according to a third embodiment in response to reception of the printing result information. In FIG. 16, the steps which are essentially the same as corresponding steps in the process illustrated in FIG. 14 are designated by the same reference numerals, and a description thereof will be omitted.

As illustrated in FIG. 16, in the third embodiment, step S542 is performed instead of the step S541 in the process illustrated in FIG. 14. In step S542, the job renewal unit 18 deletes the user ID included in the printing result information from the proxy IDs of the job information item stored in the job information storage unit 112 and corresponding to the job ID included in the printing result information.

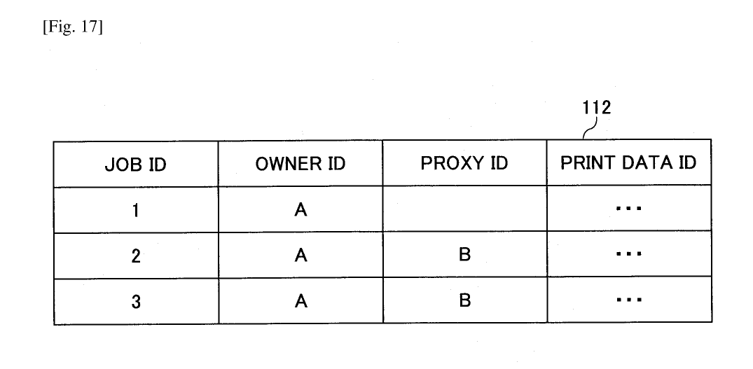

FIG. 17 is a diagram illustrating an example of a renewed job information storage unit according to the third embodiment. In the example illustrated in FIG. 17, the job information storage unit 112 is renewed after the printing result information indicating the success of the print job of the job ID “2” is received similar to FIG. 15. Further, the print job has been performed by operation of the image forming apparatus 20 by a user C. Hence, the printing result information includes a user ID “C” of the user C. In this case, the user ID “C” is deleted from the job information item with the proxy ID “2” as illustrated in FIG. 17.

In the third embodiment, with respect to the print data with which the print job is successfully performed, the association between the owner ID and the proxy ID of the proxy in charge of performing the print job is canceled. Hence, in the third embodiment, even when the printing of the print data is performed by a proxy, other proxies and the owner are able to perform the print job again.

Note that, in the foregoing embodiments, the processing of steps S530 to S580 of FIG. 12, the processing of steps S521 to S580 of FIG. 14, and the processing of steps S521 to S580 of FIG. 16 may be performed immediately after the step S404 in the process illustrated in FIG. 11 is performed. Namely, renewal of the job information may be performed in response to the transmission of the print data to the image forming apparatus 20. In this case, in the processes illustrated in FIG. 14 and FIG. 16, the user operating the image forming apparatus 20 may be identified based on the user ID included in the job list request received at the step S301 in the process illustrated in FIG. 10.

In the foregoing embodiments, the print data has been described as an example of data to be output by an apparatus. However, when the apparatus to output the data is a projector, the data to be output by the projector may be data in a format conforming to the standard projector requirements (e.g., JPEG format or PDF format). In other words, the foregoing embodiments may be applied to an apparatus other than the image forming apparatus 20, such as a projector.

In the foregoing embodiments, the combination of the client terminal 10 and the image forming apparatus 20 is an example of an information processing system. The client terminal 10 is an example of an information processing apparatus.

The image forming apparatus 20 is an example of an apparatus. The user ID is an example of a user identifier. The print data storage unit 111 is an example of a storage unit. The proxy ID is an example of one of user identifiers for identifying one or more users different from a user of an information processing apparatus. The data management unit 17 is an example of a first transmission unit. The job list acquisition unit 223 is an example of a second transmission unit. The print data request unit 224 is an example of a reception unit. The job execution unit 225 is an example of an output unit. The proxy information register request unit 15 is an example of a storage processing unit. The authentication server 30 is an example of a predetermined storage device. The proxy information acquisition unit 222 is an example of an acquisition unit. The terminal address is an example of an apparatus identifier. The job renewal unit 18 is an example of a cancellation unit.

The information processing system according to the present disclosure is not limited to the above-described embodiments, and variations and modifications may be made without departing from the scope of the present disclosure.

The present application is based upon and claims the benefit of priority of Japanese Patent Application No. 2015-143729, filed on Jul. 21, 2015, the contents of which are incorporated herein by reference in their entirety.

### REFERENCE SIGNS LIST

1 printing system
10 client terminal
11 login control unit
12 print instruction reception unit
13 print data generation unit
14 job information generation unit
15 proxy information register request unit
16 job list reporting unit
17 data management unit
18 job renewal unit
19 proxy information delete request unit
20 image forming apparatus
21 controller
22 scanner
23 printer
24 modem
25 operation panel
30 authentication server
31 authentication unit
32 user information management unit
33 proxy information management unit
34 user information storage unit
35 proxy information storage unit
100 drive device
101 recording medium
102 auxiliary storage device
103 memory device
104 CPU
105 interface device
106 display device
107 input device
111 print data storage unit
112 job information storage unit
211 CPU
212 RAM
213 ROM
214 HDD
215 NVRAM
221 login control unit
222 proxy information acquisition unit
223 job list acquisition unit
224 print data request unit
225 job execution unit
B bus

1. An information processing system comprising:
an information processing apparatus, a computer, and an apparatus which are connected via a network,
the information processing apparatus including a first processor configured to implement
an instruction reception unit configured to receive from a user an instruction for outputting data at the apparatus, the instruction including a designation of the data and one or more proxy users allowed to output the data,
a storage unit configured to store the data associated with the one or more proxy users,
a register request unit configured to transmit a register request of the proxy user via the network, so that the computer manages the proxy user associated with the information processing apparatus having stored the data which the proxy user is allowed to output, and
a transmission unit configured to transmit the data stored in the storage unit and associated with the user on the apparatus,
the computer including a second processor configured to implement
a user information storage unit configured to store an address of the information processing apparatus for communication via the network, and
a proxy information management unit configured to manage, in response to the register request, the proxy user, included in the register request, and the information processing apparatus, having transmitted the register request, which are associated with each other,
the apparatus including a third processor configured to implement
an acquisition unit configured to acquire the address of the information processing apparatus associated with the user on the apparatus by the proxy information management unit,
a reception unit configured to receive the data associated with the user on the apparatus among data stored in the storage unit of the information processing apparatus communicated based on the acquired address, and
an output unit configured to output the data received by the reception unit.

2. The information process system according to claim 1, wherein the first processor is configured to delete the data stored in the information processing apparatus in response to the outputting of the data by the apparatus, and the proxy information management unit is configured to delete, in response to a delete request sent from the information processing apparatus after the outputting of the data by the apparatus, the association between the proxy user and the information processing apparatus among associations between proxy users and information processing apparatuses managed by the proxy information management unit.

3. The information process system according to claim 1, wherein the proxy information management unit is configured to delete the association between the proxy user and the information processing apparatus when the proxy user is no longer allowed to output the data stored in the information processing apparatus after the data having been output is deleted from the storage unit.

4. An information processing method performed by a system including an information processing apparatus, a computer, and an apparatus which are connected via a network, the information processing method comprising:
receiving, by the information processing apparatus, from a user an instruction for outputting data at the apparatus, the instruction including a designation of the data and one or more proxy users allowed to output the data;
storing, by the information processing apparatus, the data associated with the one or more proxy users;
transmitting, by the information processing apparatus, a register request of the proxy user via the network, so that the computer manages the proxy user associated with the information processing apparatus having stored the data which the proxy user is allowed to output;
transmitting, by the information processing apparatus, the data stored in a storage unit of the information processing apparatus and associated with the user on the apparatus;
storing, by the computer, an address of the information processing apparatus for communication via the network;
managing, by the computer, in response to the register request, the proxy user, included in the register request, and the information processing apparatus, having transmitted the register request, which are associated with each other;
acquiring, by the apparatus, the address of the information processing apparatus associated with the user on the apparatus by the computer;
receiving, by the apparatus, the data associated with the user on the apparatus among data stored in the storage unit of the information processing apparatus communicated based on the acquired address; and
outputting, by the apparatus, the received data.

5. The method according to claim 4, further comprising deleting, by the information processing apparatus, the data stored in the information processing apparatus in response to the outputting of the data by the apparatus, wherein the managing includes deleting, by the computer, in response to a delete request sent from the information processing apparatus after the outputting of the data by the apparatus, the association between the proxy user and the information processing apparatus among associations between proxy users and information processing apparatuses managed by the computer.

6. The method according to claim 4, wherein the managing includes deleting, by the computer, the association between the proxy user and the information processing apparatus when the proxy user is no longer allowed to output the data stored in the information processing apparatus after the data having been output is deleted from the storage unit.

7. A computer which is connected to an information processing apparatus and an apparatus via a network, comprising:
a processor configured to implement
a user information storage unit configured to store an address of the information processing apparatus for communication via the network,
a register request reception unit configured to receive a register request of a proxy user transmitted by the information processing apparatus in response to an instruction for outputting data at the apparatus from a user on the information processing apparatus, the instruction including a designation of the data and one or more proxy users allowed to output the data, and
a proxy information management unit configured to manage, in response to the register request, the proxy user, included in the register request, and the information processing apparatus, having transmitted the register request, which are associated with each other.

8. The computer according to claim 7, wherein the processor is configured to delete, in response to a delete request sent from the information processing apparatus after outputting of the data by the apparatus, the association between the proxy user and the information processing apparatus among associations between proxy users and information processing apparatuses managed by the proxy information management unit.

9. The computer according to claim 7, wherein the processor is configured to delete the association between the proxy user and the information processing apparatus when the proxy user is no longer allowed to output the data stored in the information processing apparatus after the data having been output is deleted from the information processing apparatus.
